(19) United States
(12) Patent Application Publication
(10) Pub. No.: US 2011/0164246 A1
(43) Pub. Date: Jul. 7, 2011

(54) NEXT GENERATION FLOW CYTOMETER SORTER

(75) Inventor: Andy Riddell, Nussloch (DE)

(73) Assignee: EMBL HEIDELBERG, Heidelberg (DE)

(21) Appl. No.: 12/997,837

(22) PCT Filed: Jun. 10, 2009
(86) PCT No.: PCT/EP09/04205

§ 371 Date: Feb. 11, 2011

(30) Foreign Application Priority Data
Jun. 13, 2008 (EP) PCT/EP2008/004783

(51) Int. Cl. G01J 3/44

(52) U.S. Cl. 356/301

(57) ABSTRACT

The invention relates to a method for sorting particles and a corresponding sorting device, Thereby the particles comprise at least one constituent and the particles are provided by a flow cytometry device. By using coherent anti-Stokes Raman spectroscopy (CARS) certain characteristics of the at least one constituent are detected. A subsequent sorting of the particles bases on the detection results from the CARS.

This application claims the priority of the PCT application with the application No PCT/EP 2008/004783.

### FIELD OF THE INVENTION

The invention relates to sorting devices. In particular the invention relates to a method for sorting particles in combination with a flow cytometer, a device for sorting particles in combination with a flow cytometer and a computer program element.

### BACKGROUND OF THE INVENTION

In different fields of the economical life, specific demands on animals with certain gender has arisen in the last decades. This consequently has an impact on livestock breeding especially on the methods and on the devices that are used in this technical field. Breeding for example for the branch of the milk producing industry has the aim to increase the rate of female offspring to increase the efficiency of the milk production. Whereas in sheep, swine or beef breeds the male offspring are preferred as they grow faster and hence lead to a more efficient meat production. But also for biological research purposes it is quite favourable to plan the gender of animal offspring.

Older techniques of planning the sex of animal offspring have been involving complicated and very extensive medical steps like In Vitro Fertilisation (IVF) and selecting the resultant embryos into male and female, then transplantation of the desired embryo into a fertile animal. This means that the whole process of insemination must have happened in vitro. But even techniques that use artificial insemination in vitro before separating the offspring according to their sex may take a relatively long time and may also involve complex methodical steps.

More recent techniques already start with the separation at the cell level before the insemination has happened. Such a preselection distinguishes between differently sexed sperm within the semen of for example a stock bull.

Cells contain, among other matter, a set of paired chromosomes called autosomes that carry the genes that determine nearly all characteristics of the physical appearance of the living organism. For example eye colour, hair colour or the fingerprint. However there is one exceptional pair of chromosomes that is called the sex chromosomes, and they carry the genetic information that specifies gender. Thereby an egg of a female contains one chromosome of each pair of autosomes and a X-chromosome. Whereas the male sperm contains also one chromosome of each pair of the autosomes and either a X-chromosome or a Y-chromosome. During the process of insemination it is crucial for the gender of the offspring, what type of sperm unites with the female egg. In the case of a sperm with an X-chromosome uniting with the egg, the offspring is female (XX pair of sex chromosomes). Whereas in the case of a sperm with a Y-chromosome uniting with the egg, the offspring will be male (XY pair of sex chromosomes).

One recent sperm sorting technology, that distinguishes between sperm with an X-chromosome and sperm with an Y-chromosome and therefore preselects the sex of potential offspring is based on marking the sperm with fluorescent dye. In different method steps the probe, that is to be analyzed, is prepared with different materials, like bisbenzimide or a general fluorochrome. These materials might later on be detected with for example flow cytometry and a fluorescent sensitive set up. Thereby specific time and temperature limits have to be taken into account during preparation.

### SUMMARY OF THE INVENTION

It may be an object of the invention to provide for an improved sorting of particles.

This object may be realized by the subject-matter according to one of the independent claims. Embodiments of the present invention are described in the dependent claims.

The described embodiments similarly pertain to the method for sorting particles, the device for sorting particles and the computer program element. Synergetic effects may arise from different combinations of the embodiments although they might not be described in detail.

Further on, it shall be noted that all embodiments of the present invention concerning a method, might be carried out with the order of the steps as described, nevertheless this has not to be the only and essential order of the steps of the method. All different orders and combinations of the method steps are herewith described.

According to a first exemplary embodiment of the invention a method for sorting particles is presented, wherein the particles comprise at least one constituent. Further the method comprises a step of providing the particles in a flow cytometry device, detecting characteristics of the at least one constituent by coherent Anti-Stokes Raman spectroscopy and sorting the particles based on detection results.

In the following possible further features and advantages of the method according to the first exemplary embodiment will be explained in detail.

It shall be noted that in the context of this invention the following definitions and abbreviations will be used.

### CARS:

The term CARS will be used instead of coherent Anti-Stokes Raman spectroscopy. As will be explained below in detail also Polarization CARS (PCARS) and Multiplex CARS (MCARS) Spectroscopy may be applied if desired in each exemplary embodiment of the invention, even if the embodiment is described with CARS.

### Particle:

The term particle comprises all kinds of matter that is analyzable by CARS. Therefore all kinds of liquids, gases or solid state matter or any kind of mixtures of these are included in the term particle. For example cells, sperm, DNA, viruses, bacteria, tissues, nano-particles, sand, metal or semi conducting particles, any kind of exhaust gases, plastics, polymers or medical and pharmaceutical substances.

### Constituent of a Particle:

Furthermore the term constituent of a particle is used in the sense of an ingredient or a substantial element of the particle. In the case of DNA being the particle, the base thymine is a constituent of the DNA. But also a chemical group like a “O—H-group” is comprised within the term constituent. Furthermore any atom of a particle may be meant by the term constituent.

It should further be noted that it should not limit the scope of this invention when using the phrase “exciting the particle” instead of “exciting the constituent of the particle”. If for example sperm is the particle and the DNA backbone shall be the constituent of the sperm, then by exciting the DNA backbone it should be understood, that also the sperm as the whole particle is excited. Also if only one chemical bond of a constituent of particle is excited, the whole particle and the constituent should be understood as excited.

### Detecting Characteristics:

The term detecting characteristics hereby describes, that by using CARS, an electromagnetic signal sent out by a constituent of the particle is detected. This signal is sent out, as the constituent or the particle has been excited by the incoming laser fields of the CARS set up. Photons that are sent out from the constituent are detected and converted into signal, that might then be further processed. Thereby optical transitions between the energetic ground state of the constituent, excited states like vibrational states, virtual states and electronical states are detectable, as they send out characteristical electromagnetic radiation.

### Light:

The term light shall in the context of this invention comprise the whole electro magnetic spectrum. As specific frequencies used in CARS excite specific particles to specific excited states, and as the application of the invention shall not be limited to any kind of matter that is to be analyzed, all electro magnetic frequencies shall be comprised.

Flow Cytometry device, Flow Cytometer and Flow Cytometry Purposes:

It should explicitly be noted, that the terms flow cytometry device, flow cytometer and flow cytometry purposes must not be understood in such a way, that any part of an optical excitation or optical detection set up has cogently to be comprised, like for example in a fluorescent flow cytometry measurement set up. In other words: the gist of the flow cytometry device, the flow cytometer and the gist of the flow cytometry purposes in the context of this invention are to cause a propagation of the particles, in order to make them pass the CARS laser field.

In the following the process of CARS is explained in more detail.

Coherent Anti-Stokes Raman spectroscopy (CARS) is a version of Raman spectroscopy, where particles or constituents of particles are stimulated during their vibrational state to generate an Anti-Stokes shifted photon emission (blue shifted), resulting from the vibrational state of a particle or constituent of a particle. Powerful lasers are used in this technique, either in a continuous wave regime or in a pulsed regime. The characteristic CARS signal emission is achieved by using photons at two different frequencies: a higher frequency “pump” photon and lower frequency “Stokes” photon, so CARS is a multi photon process. Thereby the pump beam may also be called the probe beam and the pump photons may accordingly be called the probe photons. In other words: In order to generate a CARS signal two photons of different frequencies are mandatory necessary. But the two frequencies have to be specifically chosen in accordance with the particles or the energetic states of the constituent. When these two populations of coherent photons combine, they form a modulated electric field consisting of a high carrier frequency and a low “beat” frequency. This is described in FIG. 2. A particle or constituent of a particle is resonantly excited when the beat frequency equals a vibrational frequency of the particle or of the constituents of a particle. Unlike Raman based spectroscopy, the basic CARS method targets a specific Raman region rather than the entire Raman spectra. In other words CARS concentrates on a predefined bond or on a predefined molecule by choosing the frequencies with which the particle is irradiated. In the second step, a second pump photon mixes with the polarization field of the excited bond, resulting in the stimulated emission of an Anti-Stokes photon that is more energetic than the incoming photons. This is shown in FIG. 3. Unlike normal linear processes, where light scatters in all directions, in the simple CARS interaction the Anti-Stokes signal, recovers the momentum and energy of the incident photons, forcing the Anti-Stokes photon to emit in the same direction as the incident photons in a coherent manner. In this coherent laser-like process, photons are in phase with each other. The newly stimulated emission provides a more easily detected shorter wavelength than the excitation laser fields, at a wavelength removed from the redshifted autofluorescence of the particle, overcoming a major difficulty in conventional Raman spectroscopy. Further understanding of the CARS process requires considering the combination of the two steps above as a frequency mixing process, which stresses the big technological and fundamental differences to techniques like fluoroscopy. When multiple photons interact the applied electric field relates to the induced dipole moment P like:

P=X(1)E1X(2)E2 1 X(3)E3 1 . . . ,

where X is the electronic susceptibility of the material, which describes the material's properties by a set of constants, including molecular resonances and concentrations. The higher order terms, e.g., X(3)E3 correspond to higher order vibrational modes that are only accessible by the simultaneous interaction of multiple photons.

The CARS method leads to advantages when adapting this method for flow cytometry where there may be a need for a method that does not require staining. Staining can interfere with the processes under investigation such as signal transduction. Furthermore by using CARS in a flow cytometer it is possible to avoid cytotoxic and mutagenic stains currently used in for example cell applications. Especially in the case of sorting sperm the untoxic interaction between the photons and the sperm maintains the viability of the sperm, which may be a crucial advantage for breeding purposes.

Beyond this the CARS method used in flow cytometry may not require an orientation of the particle, as the CARS signal intensity may be high enough. Furthermore it may be avoidable to have to use two detectors like for example in a fluorescence measurement set up. Therefore the risk of technical problems may be reduced by using CARS for analyzing and sorting particles in a flow cytometry set up.

The CARS signal itself has a relationship to concentration and pressure that is quadratic in nature. It may also yield to a signal that may be five orders of magnitude greater than that of Raman Spectroscopy.

This method of particle sorting may be used as a teaching aid in schools or as a cheap and inexpensive flow cytometer. It might also be used as analytical tool for any kind of particles, which tool does not need any staining.

### Sorting:

After having detected characteristics of the at least one constituent a sorting step based on the detection results may be made. The criterion after which the sorting is done may, for example, be whether the CARS signal of a particle has reached a predefined intensity threshold or not. But also other criteria that correspond to detection results are possible. In other words: the result of the question is the particle a male or a female sperm may be the criterion for sorting in a male sperm and a female sperm population.

On exit of the jet from the nozzle, the particle travels with the jet through the lasers illumination point on the jet where the CARS signal is generated and detected and analysed. Physically the sorting may be supported by applying a sonic wave (e.g. a sinusoidal wave) to the jet of the particles and a sheath fluid leaving a nozzle of the used flow cytometer. The sound wave causes regular, but small amounts of stretching and compression of the jet as it leaves the nozzle. The perturbation travels down the jet and it grows exponentially until surface tension creates empty droplets and droplets with particles inside. This effect is very regular and this droplet ‘break-off’ point is fixed in time.

After the signal pulse has been analysed and digitised, the digital representation of the pulse may be sent to a classifier electronics to detect whether there was another particle in the droplet that was created for only one particle. This would be to ensure different levels of purity-to-recovery ratio for the particles. Furthermore the use of adjustable look-up tables means, that the classifier looks to see if the digitised pulse falls within a selectable region, where the region would be a range of values corresponding to the intensity of the original pulse.

If the digitised pulse is within the look-up tables range and the purity-to-recovery ratio is correct, then a sort decision may be classified and sorting can be processed.

The actual mechanical sorting of the particle droplet may be made by an electrical voltage being placed on the stream of particles coming out of the flow cytometry device at the time the particle reaches the break-off point of that jet. As the particle containing droplet breaks away from the jet, the electrical charge is stored in the droplet. The droplet then falls through and electric field and is attracted to either the cathode or anode (depending on the charge applied) and lands in a container.

As the system may be driven with a high flow rate up to 30.000 particles per second it may lead to an increase of effectiveness of sorting. This may make the method very interesting for industrial application in different fields of industry, where fast and accurate sorting is demanded. Coincidence event, that is particles in the jet that are so close together that they will end up in one droplet follow a Poisson statistics and are related to event rate and droplet formation frequency. They may be detected and the sort instruction for them can be aborted. Also particle rates that are too close together for the electronics to separate them can be detected and aborted. In general inaccuracies in electronic such as base line restoration circuits and errors in ADC conversion add to the overall error.

Because the CARS signal is blue shifted and therewith free of fluorescence, CARS is an optical technique that is far away from conventional flow cytometry.

According to another exemplary embodiment of the invention the particles are sperm and the sorting step comprises sorting the sperm separately into X- and Y-chromosome-bearing populations.

According to another exemplary embodiment of the invention the sorting comprises measuring the intensity of the CARS signal and sorting on bases of the measured intensity, wherein X- and Y-chromosomes are separated on basis of the intensity measurement.

Because the X chromosome contains more DNA the female sperm (X) has got a higher concentration of the constituents of the DNA for example of the phosphate backbone of the DNA or any DNA building base like adenine. Therefore the emitted CARS signal will be much more intense, when illuminating a female sperm compared to a male sperm under the same illumination and particle concentration conditions.

This method in comparison to the any fluoroscopic sperm measurement may yield better viability for the sperm. Fluoroscopic measurements require the unavoidable introduction of a fluorescent dye to the sperm to enable detection. This introduction can cause the sperm to die or not function properly. The dye may also cause mutagenesis and damage the DNA under the right conditions.

In this invention, detection is based on the interaction of the natural sperm with the incoming photons where no fundamental change of the sperm may occur.

Another advantage of the invention, is that the natural refraction index of the sperm is not changed by adding any staining matter. This may lead to more constant and reproducible optical measurements, as this factor which influences the scattering characteristics of the sperm and its constituents may be avoided.

Compared to fluoroscopic measurements at sperm, where fluorescent signals are mostly collected only from the edge and flat side of the sperm nucleus, CARS signals in combination with a flow cytometer may be generated in each constituent that is to be addressed by CARS and that is illuminated with the incoming pump and stokes beam. This may lead to a better signal quality or increase the important signal to noise ratio of the measurement.

Furthermore the orientation of the sperm may not matter because if the focus spot of the incoming CARS signal (pump and Stokes beam) is big and long enough to accommodate the sperm head in total, then all the DNA may interact with the laser and generate a consistent CARS signal. This may lead to an advantage of the inventive method of combining flow cytometry with CARS, as special orientation devices and orientation method steps may be avoided.

By this inventive method an increased through put of sperm may be reached, which makes the method advantageous for industrial sperm sorting application. A value up to 30.000 intact sperm per second may be reached with an increased accuracy and with conserving the viability of the sperm.

According to another exemplary embodiment of the invention the method further comprises the following steps: introducing the particles or a particle suspension to the centre of a flow of a sheath fluid, wherein to form a co-axial flow that is compartmentalised, wherein the particles flow singly in a stream of the sheath fluid. Furthermore the steps of providing for a first coherent light source for emitting a first light beam comprising photons of a first frequency, providing for a second coherent light source for emitting a second light beam comprising photons of a second frequency and spatially overlapping the first and second light beams to generate a modulated light field at a focal point are comprised. Thereby the first and second photons are prepared in such a way, that their phases match at the focal point, wherein the first and second frequencies are predefined in such a way, that a difference of the first and second frequency is equal to a vibrational eigenfrequency of the at least one constituent of the particle. Also bringing the particles or the suspension of particles to an interaction with the modulated light field at the focal point, stimulating an emission of a coherent blue shifted photon from the at least one constituent of a particle by the interaction with the modulated light field and using a signal of the blue shifted photon as detection result are steps of the method.

This exemplary embodiment of the invention describes single steps of flow cytometry in combination with CARS analysis.

Thereby the particles and the sheath fluid may be compartmentalised in such a way, that the particle is focused to the centre of the stream and the sheath fluid is on the outside of the stream. In order to be able to analyze the particles later on with the CARS method, they are spatially separated within the stream along their moving direction.

The first and the second coherent light sources are thereby the pump laser and the Stokes laser which a brought to a spatial overlap for example at the focal point to resonantly excite the particle or a constituent of the particle.

Thereby any kind of laser source like a gas laser, a chemical laser, a excimer laser, a solid state laser, a fibre hosted laser, a photonic crystal laser, semiconductor laser, a diode laser, a dye laser or a free electron laser may be used for the first and second coherent light source. Furthermore the used lasers may be run in a continuous wave or in a pulsed regime. The light sources may also be tuneable in frequency and intensity.

When the light sources are a pulsed laser, there may be certain intensity requirements with a high peak power that are combined geometrically and in phase. In normal flow cytometers, that aren't combined and adapted for CARS, the lasers are spatially separate and focused to different parts of the stream. If they are collinear to the stream there may not be enough power and the beams are not designed to be phase matched as they may be in CARS.

Pulse lasers may run at for example 80 MHz and may deliver over 340 kW of light for the pump and the Stokes source. A typical time of flight through the focus may be, for example, 2 μusecs. This means that at 80 MHz, the laser will yield 160 pulses in 2 μsecs. That is 160 pulses from the laser in order to assay the CARS signal. Most commercial cytometers are not designed to handle pulse lasers, indeed most commercial cytometers use continuous wave lasers and do not handle such powers. Therefore special mechanical and optical adaptation between the flow cytometry device and the CARS set up has to be fulfilled, in order to realize the inventive combination.

The spatial overlap of the first and second light beams is used to combine the two populations of coherent photons, so that they form a modulated electric field consisting of a high carrier frequency and a low “beat” frequency. This modulated light field is then applied to the sample or the particle. The spatial overlap of the two beams may also be realised before the focal point and may then travel quasi linear to the focal point, where the excitation of the particle and the CARS signal generation happens. There are a number of different laser excitation geometries that result in mixing the pump and Stokes beam into the particle. Any laser excitation geometry shall be comprised within this description.

Also beam shaping optics may be applied to ensure that the energy from the pump and Stokes beams evenly illuminate the particle. Beam shaping may be done with for example a 4 f that is, femtosecond pulse shaping in which diffraction gratings are used to direct different frequency (wavelength) components into different directions and each frequency component is focused at a particular spot in the focal plane. A second grating and a mirror are used to recombine the different frequency components and therefore can shape the beam. A pulse shaper with mechanical slit in its Fourier plane or similar will also give the pulses a sin-square intensity profile.

Thereby the term of phase matching is describing the amplitudes of the pump and Stokes beams at a focal point. The pulse generation of both separate laser sources may be managed, controlled and monitored in such a way, that both pulses arrive at the same time at the focal point or at the point where the particle is to be analyzed. A small time deviation of the pulses may be allowed up to a predefined time limit, that may for example correspond to the half-life of the excited state of the particle or the constituent.

It should further be noted for the whole content of this invention, that the difference of the first and second frequency may also be equalized to any kind of eigenfrequency of the at least one constituent of the particle. For example a rotational eigenfrequency is possible.

As the CARS method produces spectra in chemical species, this technique contains information about the state of these molecules in terms of their temperature, pressure and state, vibrational and rotational. These parameters are generally not examined in flow cytometry. Furthermore the inventive combination of CARS and flow cytometry may yield to more precision compared any method using fluorescence.

The step of bringing the particles or the suspension of particles to an interaction with the modulated light field at the focal point comprises the stream of the particles and the sheath fluid to for example the end of a cuvette, duct, pipe or tube, an which end for example the focal point may be situated. By passing the cuvette, the particles falls in and through the modulated light field and are excited and a CARS signal is generated.

Furthermore this CARS signal generation means the stimulation of an emission of a coherent blue shifted photon from the at least one constituent of a particle by the interaction with the modulated light field. Subsequently the use of the signal of the blue shifted photon as detection result may be processed.

According to another exemplary embodiment of the invention the signal of the blue shifted photon is based on a DNA content of the particles.

This may be a special form of the specific targeting of pump and Stokes frequencies. These two frequencies are defined in such a way, that the frequencies target a part of the DNA structure of a particle, that is to be analyzed, such as a PO₄ backbone of the DNA. The DNA in sperm is tightly condensed. In bovine for example, the male sperm (Y chromosome) has less Adenine (A) and Thymine T, owing to the omission of part of the X chromosome. So targeting at A or T with corresponding pump and Stokes frequency is another possible excitation set up for distinguishing between male and female sperm. There may be many possible candidates that may be targeted by the CARS laser field.

Generally the X chromosome contains more DNA, therefore the female sperm (X) has got a higher concentration of the constituents of the DNA for example of the phosphate backbone of the DNA or any DNA building base. Therefore the emitted CARS signal will be more intense, when illuminating a female sperm compared to a male sperm under the same illumination and particle concentration conditions. This leads to a unambiguous and fast sperm separation possibility by the combination of CARS with flow cytometry.

According to another exemplary embodiment of the invention the difference of the first and second frequency is equal to a vibrational eigenfrequency of one of the elements out of the group consisting of a phosphate backbone of the DNA, a base adenine, a base thymine, a base guanine, a base cytosine and each other matter, that enables to differentiate between an X-sperm and an Y-sperm.

According to another exemplary embodiment of the invention the method further comprises providing for a detector to detect the signal of the coherent Anti-Stokes Raman spectroscopy, wherein the first and second light sources are pulsed lasers and wherein the detector is synchronized with laser pulses of the pulsed lasers.

A so called forward CARS detection may be at an angle derived form the refraction of the signal. Light collection may be also possible in a backwards direction. There are a number of geometries that can be applied. CARS is at the same time a coherent and resonant process in the contrary to the scattering and fluorescence signals that occur in normal flow cytometers, that aren't combined with a CARS set up. The CARS signal is refracted away from the direction of the illumination laser beams and may be collected at an angle off the 0° collection geometry of the ordinary flow cytometer, that aren't combined with CARS. Also the CARS signal may be collected in the ‘epi’ direction that is off the 180° angle. Because CARS is coherent and directional, there may not be a 90° light collection of the CARS signal.

Furthermore the detectors geometry is not linear to the laser beam unlike the geometry of flow cytometers which tend to collect light at 0° and 90° angles. The forward angle in flow cytometers may capture light at small angle, whereas at 90° the angle is much wider. Because of the way CARS works, the exit angle of the CARS signal is not along the direction of the laser beam, so any detector for CARS signal will be off axis from the normal 0° detection path. The detectors should be placed to coincide with the peak intensity of the CARS signal. Because the CARS signal is refractive and therefore has a wavelength dependant angle, the detector should be movable, unlike the fixed position detectors of a normal flow cytometer, that is not combined with a CARS set up.

As the light to be collected from fluorescence and normal scatter is detected at 0° and 90°, it is very unclear that at other angles different optical signals may occur.

Concerning detection and processing speeds a particle or for example a sperm may be exposed to approximately 160 pulses (by for example a 80 MHz tsunami laser) from the laser beam during its flight through the focal point. Although there should be enough photons in each pulse to make detection possible, one would require detectors with fast duty cycles in order to be ready to capture each pulse. Downstream electronics may integrate these pulses from each sperm and sum the total as a single event.

There may be special means for isolating the oscillations from a droplet generator so that these oscillations do not interfere with the signal generated by the CARS process. In particular the exit angle of the CARS signal.

To get real accuracy of digitized pulse that, for example, may have an accuracy of less than 0.1% error, one may sample over 120 times, mainly because an analog digital converter (ADC) may not be synchronized to the pulse itself Using for example a pulse laser's clock to coordinate the conversion process in the ADC, one is enabled to synchronize the CARS signal capture with the laser CARS excitation pulses. One could then further sample all of the possible CARS signals available and integrate them accurately.

There may exist excitation energy requirements that are not fulfilled by normal fluorescent flow cytometry set ups. CARS may only become evident when there is enough available photons so the two photon probabilities become likely. This may be dependant on the concentration and the extinction of the chemical species that is being examined. Only with high power lasers one may be enabled to deliver required powers.

According to another exemplary embodiment of the invention the detector is movable in order to detect a refractive signal from coherent Anti-Stokes Raman spectroscopy.

The detectors should be placed to coincide with the peak intensity of the CARS signal. Because the CARS signal is refractive and therefore has a wavelength dependant angle, the detector should be movable, unlike the fixed position detectors of a normal flow cytometer, that is not combined with a CARS set up. The off axis angles of the CARS signal is due to the refractive index of the material.

According to another exemplary embodiment of the invention the phase matching of the first and second photons is achieved by applying one of the techniques out of the group consisting of boxCARS phase matching technique and trivial phase matching technique.

The trivial or collinear phase matching may be applied for example in low dispersive media like for example low-pressure gases. It may be comparatively simple to align and spatial resolution may be due to focusing. The technique of boxCARS phase matching may give a higher spatial resolution. As the overlap of the beams takes only part in the focal region, CARS radiation generation in lenses and windows may be avoidable. The beams are geometrically separated at the receiver or detector side. The difference of these two techniques is further the shown in FIGS. 8 to 10.

According to another exemplary embodiment of the invention the particles are irradiated with only two discrete frequencies of light during the coherent Anti-Stokes Raman spectroscopy.

It should explicitly be noted, that in the context of this invention CARS signals are generated by firstly defining which specific excitation transition of a specific constituent of the particle is to be addressed and thus excited by the CARS laser field. As the invention is enabled to analyze particles very fast in order to distinguish between them, like e.g. between X and Y sperm. During one analyses with CARS only this two discrete frequencies are applied to the particles.

This CARS based method distinguishes clearly from a method that scans a continuum or a quasi continuum of laser frequencies in order to have a look, which (unknown) states of the particle are excited at the moment. It is the aim of these methods, in contrary to the CARS based method according to the present invention, to find out a totally different set of parameters like for example the temperature of the particle. The aim of this method is not to separate particles on basis of detection results like the present invention is doing. Therefore a preselection of the laser frequencies that correspond to an eigenfrequency of the particle or the at least one constituent as described above is not done in this different method.

In other words the method according to the present invention analyses how much intensity of one specific frequency is emitted by the particle. In contrary to that scanning a frequency continuum and looking which frequency is emitted leads to totally different requirements for the excitation lasers and also for the detection set up. As one would have to use a quite broadband detector, one looses in resolution of intensity. This may be one of the disadvantages of applying a frequency continuum. However, the present invention which is based on CARS as described above and below overcomes these disadvantageous.

According to another exemplary embodiment of the invention the method further comprises the steps of determining the pulse width of one of the pump beam and the Stokes beam by splitting a pump pulse into two pump pulses or by splitting a Stokes pulse into two Stokes pulses; recombine the two pulses again and generating an interference; and using the generated interference to determine the corresponding pulse width.

In other words the pulse width of a laser pulse that is used for CARS is determined by firstly splitting the pulse into a first and second pulse and by interfering the two pulses afterwards. The interference signal is used for the calculation of the pulse width of the laser.

Furthermore the following measurements may be done during the inventive method in order to provide for the important parameter values that have to be known when performing such a CARS measurement: performing a laser wavelength measurement; wherein the laser wavelength is dependant on which matter or material one wants to analyze. In other words the used wavelengths are specific for the particles or the constituents of the particles that are to be detected. Furthermore the bandwidth of the pulsed lasers is measured, as not a single wavelength but a small range of wavelengths is emitted. Additionally the intensity is measured, as enough power may be necessary to drive the CARS effect on the particles or constituents of the particle. Also the pulse duration is measured in order to be able to match the length of the laser pulses or mix them. Any pulse with a desired pulse duration may be generated and used for the CARS process described in the present invention. In the following a few examples are mentioned which shall not be construed as limiting the scope of the invention as also other pulse durations may be applied. For example both lasers may be Tsunami lasers that are run at 100 femtoseconds or 4 picoseconds (ps) or one at 100 nanoseconds and the other at 4 ps etc. As will be described below in detail the matching or mismatching of the pump photons and the Stokes photon is measured by means of for example a non linear crystal. This can also be seen in FIG. 12. In other words both pulses are coordinated in space and in time during performing the method of an exemplary embodiment of the invention the.

It should be noted that the technical equipment and devices for performing the above described measurements may also be part of another exemplary embodiment of the invention.

In addition to that it should be noted that in another exemplary embodiment of the invention the use of an OPO to generate combinations of the pump/probe and the Stokes beams from a single pulse laser is possible. This makes it possible to remove a clock used for synchronisation issues because one single laser source delivers all pulses for performing the method for sorting particles by means of CARS.

It should explicitly be noted that for this and every other embodiment of the invention also Polarization CARS (PCARS) and/or Multiplex CARS (MCARS) Spectroscopy may be applied. As the CARS signal has an inherent electronic non-resonant background portion in weak vibrational signals the background can swamp the resonant CARS signal. The polarization of the resonant and non-resonant CARS signal is different and can be isolated from one another by an analyzer that rejects the background non-resonant signal and allows the resonant signal part through.

In the multiplex CARS spectroscopy a portion of the CARS signal is measured in a single shot. A broadband source for the Stokes beam is used to provide the spectral bandwidth. The pump beam is a relatively narrow band laser beam that defines the spectral resolution. The pump and Stokes beams drive multiple oscillators with different Raman frequencies within the particles or constituents of the particles and this imprints their signature into a broadband anti-Stokes signal. Spectrally resolving this signal generates a multiple-band CARS spectrum.

According to another exemplary embodiment of the invention a device for sorting particles is presented, wherein the particles have at least one constituent. Thereby the device comprises a first subdevice for flow cytometry purposes and a second subdevice for coherent Anti-Stokes Raman spectroscopy for detecting characteristics of the at least one constituent and a third subdevice for sorting the particles based on detection results.

The first subdevice, which is used for flow cytometry purposes, is in the following and in the above said to be understood as follows: The first subdevice provides for the components, that are necessary for bringing the particles into a flow towards the focal point of the two CARS lasers. As minimum features may be understood a particle entry section, a sheath fluid entry section, a flow chamber for introducing the particles to the centre of a flow of a sheath fluid and an exit section for the particles and the flow of the sheath fluid. In other words: the gist of the first subdevice is to cause a propagation of the particles, in order to make them pass the CARS laser field.

It should explicitly be noted, that the term first subdevice, flow cytometry device, flow cytometer and flow cytometry purposes must not be understood in such a way, that any part of an optical excitation or optical detection set up has cogently to be comprised, like for example in a fluorescent flow cytometry measurement set up.

The second subdevice therefore comprises at least all components, that are necessary to generate and detect a CARS signal from a particle, that is, moving in or out of a flow cytometer. For example two lasers, an optical beam shaper and tuner for the pump and Stokes beam, an oscillator for timing pulses and electronics, a detector, which is movable or static, a mirror, a focusing lens, a collection lens, a dichroic mirror, a beam stearing mirror and an amplification system, which can be linear or logarithmic. Furthermore a total a computer system for the analysis of the signals may be comprised.

Additionally electronical equipment for e.g. synchronizing two light sources for the CARS subdevice and for synchronizing the at least one detector with the excitation laser pulses may be comprised within the CARS subdevice.

According to another exemplary embodiment of the invention the first subdevice comprises a particle entry section, a sheath fluid entry section, a flow chamber for introducing the particles to the centre of a flow of a sheath fluid and an exit section for the particles and the flow of the sheath fluid.

Furthermore the first subdevice may comprise all components for applying a entire flow cytometer. This may comprise for example a flow cell, a liquid stream, which has the function of the sheath fluid. It carries and aligns the particles so that they pass single file through the light beam for sensing with CARS. The light source that is to be used depends on the excitation level of the particle one wants to address by the modulated light field of the CARS lasers.

According to another exemplary embodiment of the invention the second subdevice comprises a first coherent light source for emitting a first light beam comprising photons of a first frequency, a second coherent light source for emitting a second light beam comprising photons of a second frequency, at least one element for phase matching the photons of the first and second light source, a first detector for detecting a coherent Anti-Stokes Raman signal, wherein the first and second frequencies are predefined in such a way, that a difference of the first and second frequency is equal to a vibrational eigenfrequency of the at least one constituent of the particle.

As described above the first and second frequencies may also be predefined in such a way, that a difference of the first and second frequency is equal to any other eigenfrequency of the particle or the at least one constituent of the particle. For example rotational eigenfrequencies may be addressable.

According to another exemplary embodiment of the invention the device further comprises a second detector for detecting a coherent Anti-Stokes Raman signal in a backward direction.

There may also be additional light collection in a backward direction, and this angle may for example be as large as 30° off the backward direction to the lasers. Here the signal may be weak, but relatively noise free.

The occurrence of a backward signal has to do with the way light scatters. If light beam interacts with a single molecule or atom at certain frequencies the light will scatter equally in all directions. As more of these molecules interact, constructive and destructive interference effects build up and effectively all the energy is projected in the forward direction through constructive interference effects. Side scattering is cancelled by destructive interference effects. The backward direction, however does not completely suffer from destructive interference effects, so some of the signal propagates in that direction. The off axis angles of the CARS signal is due to the refractive index of the material and is therefore wavelength dependant. Taking this CARS signal into account may further increase the intensity of the CARS method and may increase the signal to noise ratio.

According to another exemplary embodiment of the invention the device further comprises an optical filter wherein the optical filter is adapted for separating a CARS signal in a backward direction from backwards reflected photons of the first frequency and from backwards reflected photons of the second frequency.

As explained above, the photons of the first and the second frequency are the pump photons and Stokes photons to create the CARS process. As these photons may also be back reflected an isolation of the backwards CARS signal is provided herein. The isolated backwards CARS signal may be detected independently or may be detected together with a forward CARS signal.

The optical filter may be e.g. a long pass filter that reflects wavelength dependent incoming photons. In other words the three different types of photons, firstly the above described pump photon, secondly the above described Stokes photon and thirdly the photon of the backwards CARS signal are spatially separated by the filter. Of course there may be a plurality of photons within each different types of photons. Therefore the backwards CARS signal may be used independently from the forward CARS signal as a detection result, which is depicted in the following FIG. 14. However, if desired the two CARS signals may be optically combined or summed up in order to analyze this summed signal. This combination can be seen from the following FIG. 4. As the backwards CARS signal may have an inherently better signal to noise ratio, the consideration of the backwards CARS signal for optically detecting and distinguishing between male and female sperm may lead to an improved combination of flow cytometry and CARS. Thus, the efficiency of the corresponding sorting process, which is described above and hereinafter may be increased. It should be noted that the backwards CARS signal is also called EPI CARS signal.

The optical filter may be transparent for the pump photons and the Stokes photons, but may simultaneously reflect CARS photons. In this way also a separation of backwards CARS photons may be realized. In case the back reflected pump and Stokes photons may disturb the laser functionality optical isolators may additionally be applied. This prevents from a travel back of these photons into the lasers or onto a photo diode that is used as a mismatch detector as described below. This may further enhance the accuracy of the sorting device for sorting particles according to an exemplary embodiment of the present invention.

According to another exemplary embodiment of the invention the device further comprises an optical delay line for matching photons of a first frequency with photons of a second frequency at a predefined spot.

It is of utmost importance that in the context of the delay line and the mismatch detector the term matching and mismatching relate to the simultaneous arrival of the two types of different photons at the same spatial coordinates. It should therefore explicitly not be understood as frequency matching.

In other words the pump and Stokes photons are matched by the delay line in such a way that they arrive at the same point of time at the same spatial coordinates, which coordinates define the predefined spot. This may be done by elongating or reducing the path length and/or the optical path length of the photons of the first and/or the second frequency. Furthermore the time of emission of firstly the photons of the first frequency and secondly the time of emission of the photons of the second frequency may be controlled and adapted in such a way, that both different types of photons arrive simultaneously at the desired and predefined spot. In other words the delay line is adapted to apply a zero time delay of the pump photons and the Stokes photons of the CARS generating device.

The delay line may mainly be used to adjust the synchronization of the pump pulse and the Stokes pulse.

The delay line may comprise at least one of the following elements: mirror, beam splitter, polarizing beam splitter, quarter wave plate and half wave plate. In order to provide for an elongated or reduced optical path length and/or path length these components may be applied movable within the set up of the device. Thereby components with different refractive indexes may be used.

According to another exemplary embodiment of the invention the device further comprises an additional optical arm that comprises a mismatch detector, wherein the mismatch detector is adapted for measuring a mismatch between the photons of the first frequency and the photons of the second frequency.

It is of utmost importance that in the context of the delay line and the mismatch detector the term matching and mismatching relate to the simultaneous arrival of the two types of different photons at the same spatial coordinates. It should therefore explicitly not be understood as frequency matching.

The mismatch detector may be located within an optical arm of the device which arm is entered by the pump photons and the Stokes photons via e.g. a beam splitter. This may be seen e.g. from FIG. 12. However, the amount of photons being split by the splitter into a second direction may be guided towards the sorter, where the CARS generation and the subsequent sorting takes place. In other words this above and below described mismatch measurement takes place simultaneously to the CARS generation and detection within the first and second sub-device. Thus, CARS based detection of particles or constituents of a particle within a flow cytometer, sorting may be performed simultaneously with the measurement and the control of the quality of the matching of the pump and Stokes photons.

Nevertheless according to another exemplary embodiment of the invention the optical arm of the mismatch measurement is mechanically switched to the device instead of the arm in which the sorter and the flow cytometer are situated. In other words either a mismatch measurement is performed by this embodiment or a sorting based on CARS with a flow cytometer is performed by the device.

The mismatch detector may be realized as an optical photo diode being able to detect pump photons, Stokes photons and most notably the photons of the combination of the pump and Stokes beam, which combination yields to the modulated electric field as described above and below. Further on other devices than diodes may be used to detect the combination of the photons.

The signal detected by the mismatch detector may be used as a feedback signal which is used to control the delay line and/or the generation of pulses of the pump and Stokes lasers.

The detector is adapted in such a way, that a high spatial matching, a high matching in time (synchrony of the pump and Stokes photons or pulses) and a high matching of the phases of the pump photons and the Stokes photons yields to high detector signal. The term matching may thus synonymously be used with the term overlap.

Therefore, the signal of the mismatch detector may be used to control at least one of the parameters chosen from the group comprising: length of the delay line, time of emission of the pump and/or the Stokes laser, adjustment of optical elements that focus the pump beam and the Stokes beam onto the focal spot where they combine.

According to another exemplary embodiment of the invention the device further comprises a non linear crystal, wherein the non linear crystal is adapted for converting the photons of the first frequency and the photons of the second frequency into one summed and converted photon.

The non linear crystal may e.g. be placed in the additional optical arm in front of the mismatch detector.

The non linear crystal may be e.g. beta barium borate (BBO). But of course other materials are possible. Additionally a lens may be comprised within the device to focus the pump photons and the Stokes photons onto the non linear crystal. The following process may be generated in the crystal: Frequency doubling may occur separately for each the pump photons and the Stokes photons, as they impinge onto the crystal. Thus, behind the crystal photons with two times the pump and two times the Stokes frequencies may be detectable. The lens may also be part of the device. Thirdly, after the pump and the Stokes photons have been combined the frequency doubling process takes place and a summed frequency doubled photon is emitted by the non linear crystal. Therefore, a third frequency is detectable behind the non linear crystal.

It should be noted that the magnitude of this third frequency may be used as a measure of the quality of the matching of the pump and Stokes photons. This magnitude may thus be used as a basis of an electrical feedback loop which controls a delay line. In other words the better the spatial alignment and the alignment in time of the pump and the Stokes photons are, the higher this signal of the third frequency emitted by the non linear crystal will be.

Furthermore the device may detect the three frequencies of photons spatially independent, as they may be emitted by the non linear crystal in different directions.

According to another exemplary embodiment of the invention the device is further adapted for controlling the mismatch between the photons of the first frequency and the photons of the second frequency based on a signal provided by the mismatch detector to the delay line.

Thus, a feedback line from the mismatch detector to the delay line and/or a corresponding control unit for this feedback may be comprised in the device. Also radio signals may be used to transmit the signal of the mismatch detector.

According to another exemplary embodiment of the invention the device further comprises an optical parametric oscillator (OPO) and a coherent light source; wherein the optical parametric oscillator is adapted to convert photons of the coherent light source into a pump photon and a Stokes photon.

By means of using only one coherent light source in combination with an OPO synchronisation problems of the emission of two separate sources are avoided with this exemplary embodiment of the invention. No effort for tuning or matching photons that originate from different sources is necessary. This may increase the accuracy as well as the reliability of the device and the corresponding method.

Furthermore in another exemplary embodiment of the invention a beam expander or 50-50 beam splitter is used in order to combine the two beams in space. This does not exclude the possibility of using a different ratio beam splitter e.g. an 80-20 or e.g. 90-10 etc. In addition to that it is possible to use an (e.g. off the shelf) auto correlator such as e.g. Newport's PicoScout to indicate the matching or mismatch of the two different types of photons (pump photons and Stokes photons).

It should be noted that all the above described embodiments relating to a device correspond to a method that is also part of the present invention and which method constitutes a process step of applying the described devices.

According to another exemplary embodiment of the invention the device comprises an analog digital converter (ADC) for converting the detection results, a pulse laser's clock, wherein the pulse laser's clock is used to coordinate the conversion in the ADC to synchronize a capture of a coherent Anti-Stokes Raman spectroscopy signal with excitation pulses of the coherent Anti-Stokes Raman spectroscopy.

The two lasers that give the pulsed light (pump and Stokes lasers) may be synchronised through a clock. This configuration allows a co-ordinated burst of light from the pump and Stokes beam to generate the CARS signal. One may also use this clock to synchronise the detection of the resultant CARS signal by adjusting the electronics in such a way to only capture the signal when the CARS signal is present. It may be, that one needs to take over 120 particles of the signal in order to accurately measure (to 0.1% error) the pulse. This may be because, flow cytometer measurements are normally not synchronised to the signal to be detected. In the method according to this invention, by using the clock of the lasers, one may coordinate the signal during measuring and so gain better accuracy in the measurement. By reducing the integration time of a detector it may be possible to gain in resolution and therefore increase the accuracy. This may be another advantage of the inventive method.

According to a another exemplary embodiment of the invention the device further comprises a nozzle, wherein the nozzle is part of a cuvette and wherein the first and the second subdevices are physically combined in such a way, that the interaction of the modulated light field and the particles happens within the nozzle.

In order to increase the signal intensity and by this the quality (signal to noise ratio) it may be an aim to avoid boundary layers, where the refraction index is changing. This would lead to needless absorption and scattering. By illuminating the particle to be analyzed with the CARS modulated light field inside of the cuvette, background radiation may be suppressed by the cuvette. Furthermore the usage of a cuvette avoids additional boundary layers and leads to a more index matched optical path for the light. This may further increase the detection signal quality.

Furthermore all light used in this inventive method may be propagated within fibre optics which may reduce losses and increase the CARS signal quality. For example the generated CARS signal may be coupled into an optical fibre, conducting the light out of the cuvette directly to a detector.

According to another exemplary embodiment of the invention a computer program element is presented. This element is characterized by being adapted, when in use on a device for sorting particles, to cause the device for sorting particles to perform the steps of the above in the following described method.

This computer program element might therefore be stored on a computing unit, which might also be part of an embodiment of the present invention. This computing unit may be adapted to perform or induce the performing of the steps of the method described above. Moreover, it may be adapted to operate the components of the above described device. The computing unit can be adapted to operate automatically and/or to execute the orders of a user. Furthermore, the computing unit can request the selection from a user to process the input from the user.

This embodiment of the invention covers both a computer program, that right from the beginning uses the computer program element, and a computer program, that by an update turns an existing program into a program that uses the invention.

Further on, the computer program element might be able to provide all necessary steps to fulfill the procedure of a sorting particles as described in the methods and apparatus above.

According to a further embodiment of the present invention, a computer-readable medium is presented wherein the computer-readable medium has a computer program element stored on it, which computer program element is described by the preceding or following sections.

Further on another embodiment of the present invention might be a medium for making a computer program element available for downloading, which computer program element is arranged to perform the method according to one of the above embodiments.

It may be seen as a gist of the invention, that particles in a flow cytometry device may be differentiated and therefore sorted on basis of a coherent anti-Stokes Raman spectroscopy signal. Thereby staining of the particles may be avoidable as well as applying a scan of laser frequencies.

It has to be noted that some of the embodiments of the invention are described with reference to different subject-matters. In particular, some embodiments are described with reference to method type claims whereas other embodiments are described with reference to apparatus type claims. However, a person skilled in the art will gather from the above and the following description that unless other notified in addition to any combination of features belonging to one type of subject-matter also any combination between features relating to different subject-matters is considered to be disclosed with this application.

The aspects defined above and further aspects, features and advantages of the present invention can also be derived from the examples of embodiments to be described hereinafter and are explained with reference to examples of embodiments. The invention will be described in more detail hereinafter with reference to examples of embodiments but to which the invention is not limited.

### BRIEF DESCRIPTION OF THE DRAWINGS

FIG. 1 shows a schematic image of the energy scheme of the states of a particle to be analyzed with CARS according to an embodiment of the present invention.

FIG. 2 shows a schematic image of a diagram of the modulated field due to the combination of the pump and the Stokes beam in CARS.

FIG. 3 shows a schematic image of the energy scheme of the states of a particle to be analyzed with CARS according to an embodiment of the present invention.

FIG. 4 shows a schematic view of device for sorting particles according to an embodiment of the present invention.

FIG. 5 shows a lateral view of a cuvette for a flow cytometer that may be used in another exemplary embodiment of the present invention.

FIG. 6 shows a lateral and plan view of a cuvette with a nozzle for a flow cytometer that may be used in another exemplary embodiment of the present invention.

FIG. 7 shows a schematic representation of different beam patterns for phase matching according to another exemplary embodiment of the present invention.

FIGS. 8 and 9 show schematic diagrams of the involved wave vectors in collinear and BoxCARS phase matching according to another exemplary embodiment of the present invention.

FIG. 10 schematically shows a sorting device according to another exemplary embodiment of the present invention.

FIG. 11 schematically shows a flow diagram of a sorting method according to another exemplary embodiment of the present invention.

FIG. 12 schematically shows a delay line and a mismatch detector according to another exemplary embodiment of the present invention.

FIG. 13 schematically shows a delay line and a mismatch detector according to another exemplary embodiment of the present invention.

FIG. 14 schematically shows a device for sorting particles with an optical filter to isolate a backwards CARS signal according to another exemplary embodiment of the present invention.

### DETAILED DESCRIPTION OF EMBODIMENTS

Similar or relating components in the several figures are provided with the same reference numerals. The view in the figure is schematic and not fully scaled.

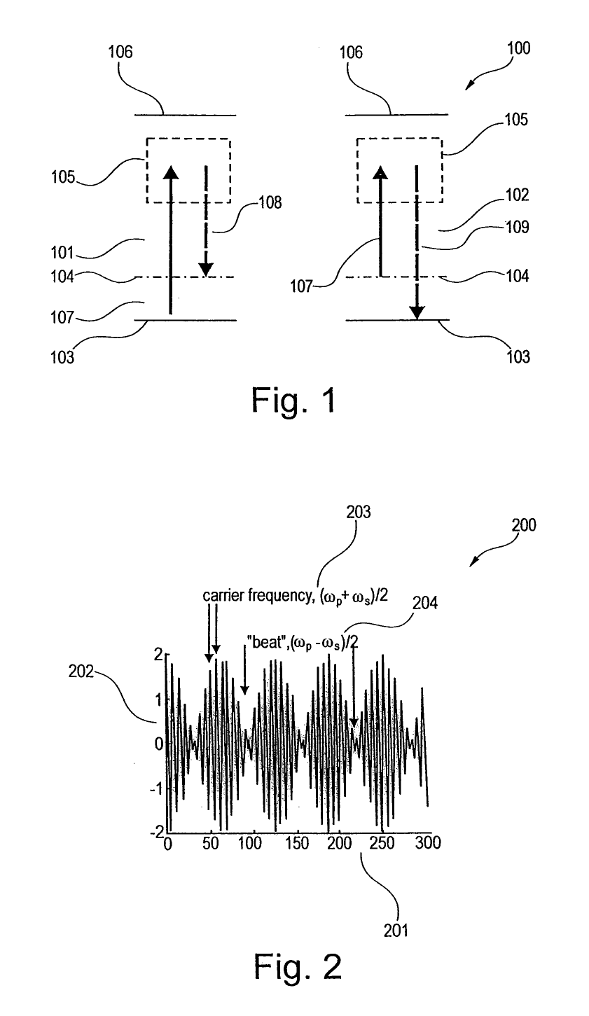

FIG. 1 shows the energy scheme of the states of a particle that is to be analyzed by the inventive method using CARS in a flow cytometry set up. Thereby on the left hand side a Stokes shifted emission of a photon 108 is shown, wherein on the right hand side an emission of an anti-Stokes shifted photon 109 is shown.

Starting from the energetic ground state of the particle, the particle is firstly excited to a virtual state 105 by absorption of a photon 107. Afterwards the particle relaxes to a lower vibrational level 104 while emitting a Stokes shifted photon 108.
Furthermore electronic states 106 are shown. But an already excited particle, being at the vibrational state 104, may absorb a photon 107 and may lead as well to a virtual state 105. Nevertheless the emission of an anti-Stokes photon 109 takes energy out of the particle and transfers it to the emitted photon.

FIG. 2 shows a diagram 200 of the modulated electro magnetic field as it results during the CARS process by combining the pump beam and Stokes beam. On the x axes 201 frequencies in arbitrary units are shown. On the y 202 axes amplitudes arbitrary units are shown. It can be clearly seen, that when these two populations of coherent photons combine, they form a modulated field consisting of a high carrier frequency 203 and a low “beat” frequency 204. A chemical bond is resonantly excited when the beat frequency equals the vibrational frequency of the bond. It shall further be noted that in the whole context of this invention instead of a vibrational frequency also a rotational state with a rotational frequency of the particle may be excited.

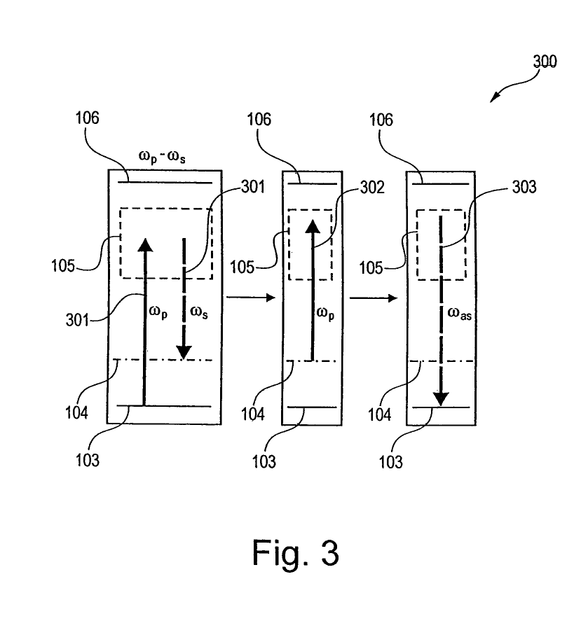

FIG. 3 shows the process that generates a CARS signal. However, the process occurs in three sequential steps as depicted in the diagram 300. A particle or a chemical bond of the particle is resonantly excited 301 when the beat frequency equals the vibrational frequency of the bond. The CARS method targets a specific Raman frequency region rather than the entire Raman spectra. In the second step, a second pump photon mixes with the polarization field of the excited bond 302, resulting in the stimulated emission of an anti-Stokes photon 303, that is more energetic than the incoming photons. Unlike normal linear processes, where light scatters in all directions, in the CARS interaction the anti-Stokes signal, recovers the momentum and energy of the incident photons, forcing the anti-Stokes photon to emit in the same direction as the incident photons in a coherent manner. In this coherent laser-like process, photons are in phase with each other.

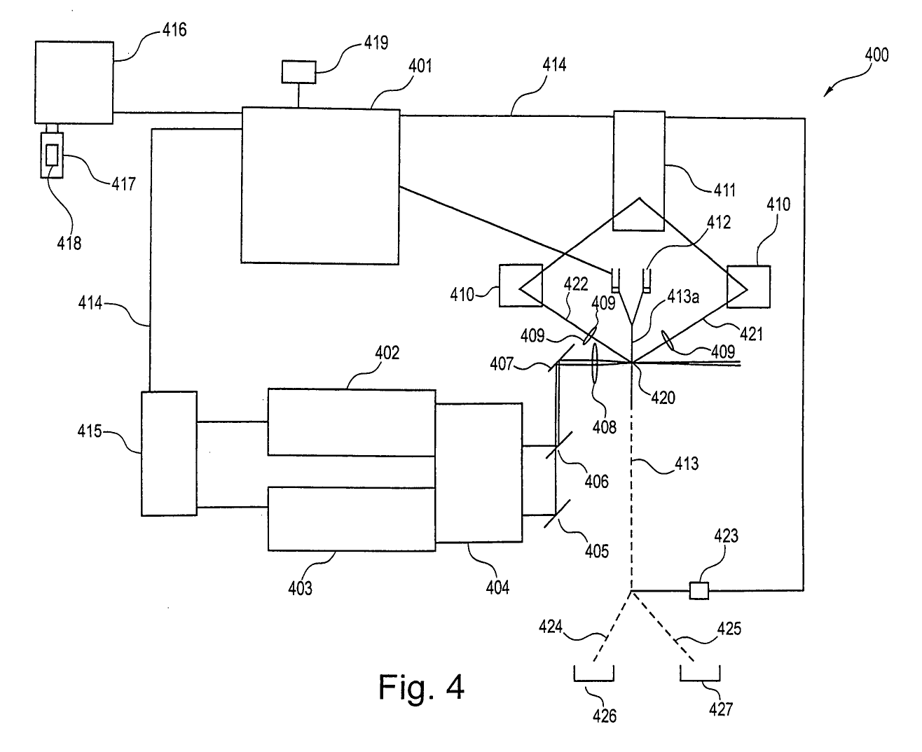

FIG. 4 shows a possible device 400 for sorting particles with a flow cytometer 412 in combination with CARS according to an exemplary embodiment of the invention. Electronical components 401 are shown, in order to control and manage a possible synchronization between the detector 411 and the generation of the laser light by the first and second laser 402, 403. For example the first laser supplies the pump beam and the second laser supplies the Stokes beam. Most conventional cytometers use small un-tunable lasers (for example diode type), with relatively low powers (hundreds of milliwatts) and are therefore are not suitable for CARS measurements.

In the following a flow cytometer or flow cytometry device 412 that might be used in an exemplary embodiment of the invention will be explained. The flow cytometry device may comprise a nozzle. The nozzle may comprise a nozzle body having a lumen through which a particle input tube for supplying a particle to the lumen is guidable. A nozzle tip may further be provided.

The nozzle body may be designed to centre a particle in the flow region of the lumen. The nozzle body may further be designed to centre the particle in the flow region of the lumen by placing the particle input tube adjacent to a centre of flow of the lumen. The nozzle body may have an adapter portion adapted for a connection to a sheath fluid container for supplying a sheath fluid concentrically around the particle after the outflow of the particle out of the opening of the particle input tube.

The detector may be chosen for being specifically sensitive for the emitted CARS signal frequency. Any kind of detector that is arranged to detect photons may be used. Furthermore also a plurality'of detectors, e.g. for detecting the forward and backward CARS signal separately may be possible.

In order to synchronize the detector 411 with the lasers 402, 403 communication lines 414 between these components and the electronics 401 are provided. Furthermore a special synchronization device 419 like for example a pulse laser's clock may be comprised. In addition a computing unit 416 is shown in FIG. 4, wherein a computer readable medium 417 like for example an external storing device is connected to the pc. By a computer program element 418, the sorting device 400 may be controlled and managed. The program element 418 may cause the sorting device 400 to perform the steps of the sorting method as described above and in the following.

The sorting device 400 further comprises an oscillator for timing the laser pulses and electronics 415, beam shaping components 404 and optical components like dichroic mirrors 405, 406, a beam stearing mirror 407 and a focusing lens 408. These components are used to align the pump and Stokes beam, which are generated by the first and second laser 402 and 403, at the focal point 420. At this focal point which is the area of interrogation of the laser field with the particles, the CARS process happens. The particles are analyzed by exciting them in the above described way. The forward CARS signal 421 and the backward CARS signal 422 are emitted in the shown directions; collecting lenses bundle the respective photons onto mirrors 410 for a forward or a backward CARS signal. Both CARS signals are detected and analyzed in the detector 411.

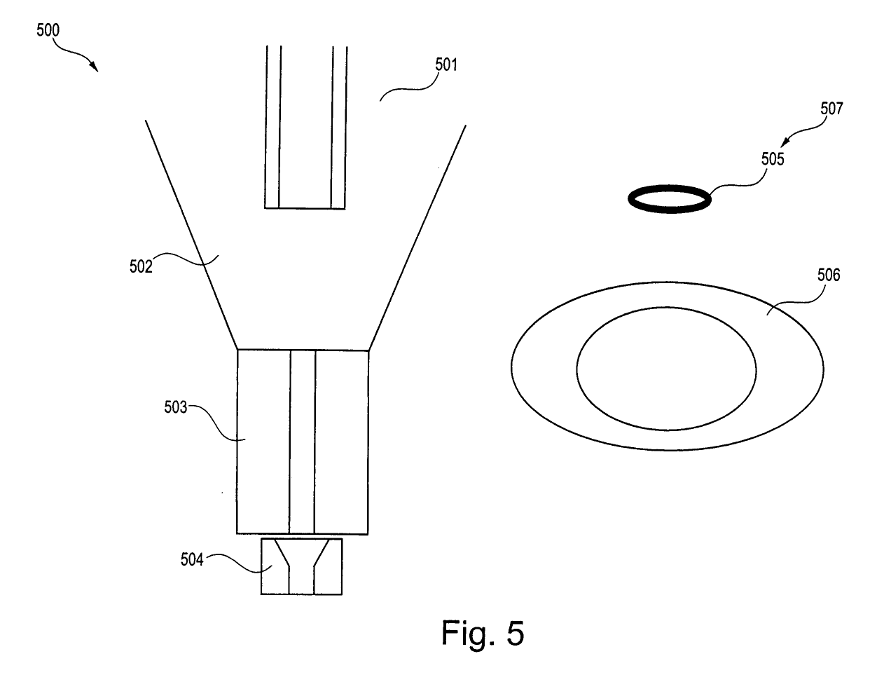

As one can clearly see, the particle jet before being analyzed with CARS 413 a comes out of the flow cytometer 412. The process within the flow cytometer is shown and described in the FIG. 5 as well as above. Particles are analysed at all into the focal point 420. After having analyzed the CARS signals by the detector 411 or by the electronics 401, the jet breaks up into defined droplets and sorted by the above described sorting process. This may for example be done by electrostatic forces, as described above. But also any kind of mechanical, electrical, magnetical or thermal sorting process may be used within this invention. This sorting is based on the detection results of the CARS signal. Is for example detected, that a sperm is a male one, the sorting mechanism 423 makes the sperm propagate in a first direction 424. It is also possible, that the sorting starts directly after the focal point 420. However sperm that are analyzed by CARS to be a female sperm, are forced to propagate in another, second direction 425. Therefore the separation on basis of the detection results defines the propagation of the particle after being analyzed with CARS. The two different kinds of particles, that have previously been mixed together, may therefore be separated in a first particle population 426 of for example male sperm and a second particle population 427 of for example female sperm.

In other words this exemplary embodiment of the invention comprises a fluidic system, an electronic system and an optical system. The fluidic system may comprise, that air is used to compress a tank of sheath fluid into the instrument. The electronic system may comprise three parts: firstly an instrument control, secondly an acquisition part and a sorting part. Furthermore the optical system may comprises a part of light excitation optics (Top Hat) and a second part for light collection.

It should be noted this embodiment of the invention shown in FIG. 4 may also be adapted in such a way that also Polarization CARS (PCARS) and Multiplex CARS (MCARS) Spectroscopy may be used to provide for an improved sorting of particles.

FIG. 5 shows on the left hand side a lateral view 500 of a cuvette of a flow cytometer, that may for example be used within this invention. Thereby a particle tube 501 and a nozzle body 502 is shown. The particles exit the tube and fall directly into the beneath nozzle body. Further down the laser interrogation area in the nozzle 503 is shown. This means, that the interaction of the laser field with the particles takes place inside the housing of the nozzle and therefore avoids background light from outside and further avoids additional boundary layers that may cause losses for the light propagation. In a further section beneath the jeweled nozzle 504 is placed. Furthermore FIG. 5 shows on the left hand side plan 507 view of a cuvette, with an exemplary diameter of the tube 505 and the nozzle body 506.

The particle tube or injection pipe may be considered as an internal structure. The injection pipe's orifice may be considered as an external structure. The point where coaxial flow starts is at the end of the injection pipe were the particle flow is injected into a shaped sheath inlet, wherein this sheath inlet is equal to the nozzle body 502. This sheath inlet is shaped to accelerate the sheath fluid and the particles in both planes, but the orientation plane will accelerate more, thus extending particle orientation. The shape of the structure creates a ribbon like stream in which sperm or particles orientate in the plane of the stream, which is the orientation plane. After a certain length of acceleration, the particles will be confined in the core of the flow and pass one at a time through a laser interrogation point where the particle is illuminated. The laser interrogation point is designed to allow light collection from different angles for example at 0° and 90° to the direction of the laser beam. The utility of the cuvette may allow many different angles to collect light. A little further, the flow leaves the cuvette through a orifice that forms a jet. The orifice may contain a piezo crystal and a sound wave may be coupled to the jet in order to perturb the jet and build for example droplets.

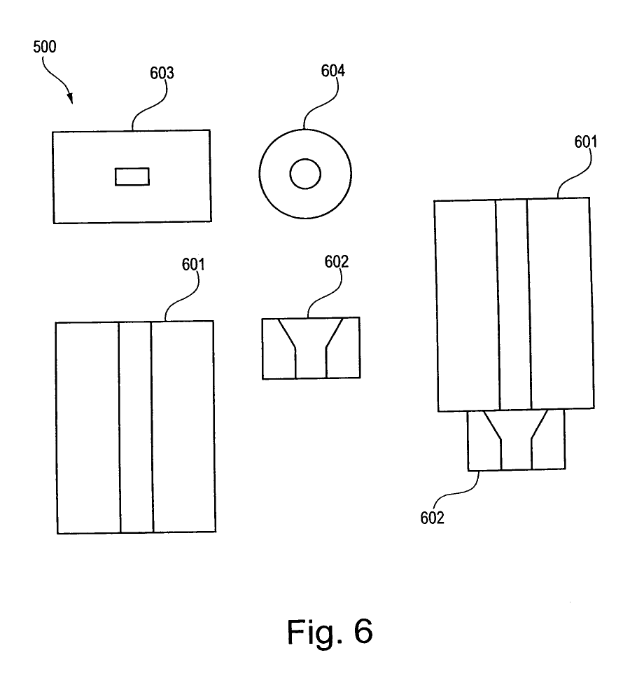

FIG. 6 shows a lateral and plan view 600 of a cuvette with a nozzle for a flow cytometer. Thereby a laser interrogation area in a nozzle 601 in lateral view is shown, as well as a jeweled nozzle tip in lateral view 602. The plan view comprises a laser interrogation area in a nozzle 603 and a jeweled nozzle tip 604.

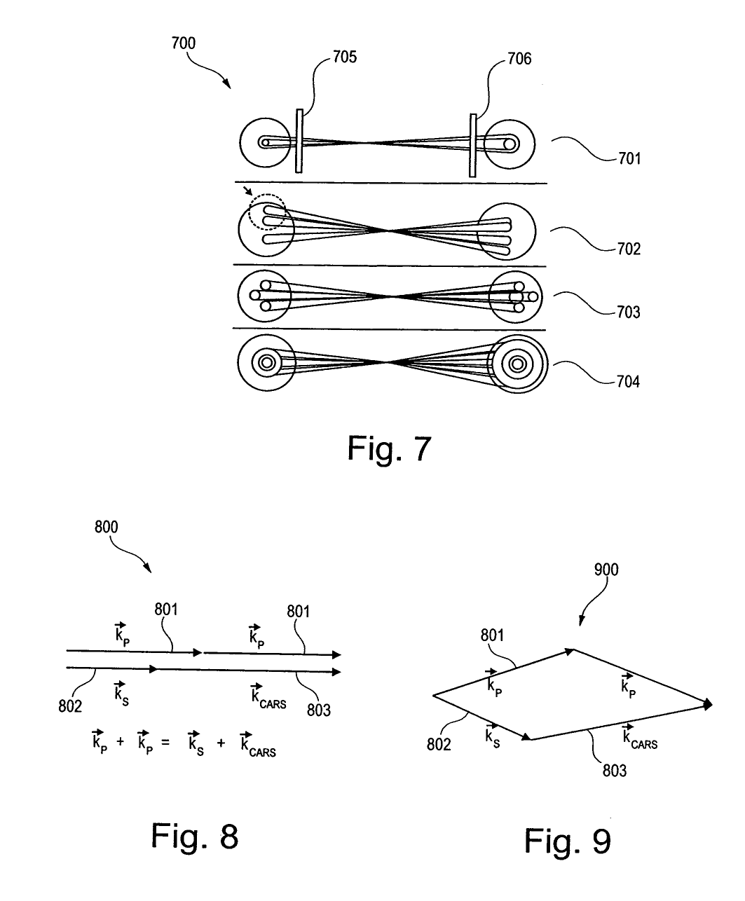

FIG. 7 shows 700 different beam patterns for phase matching that are possibly used during different exemplary embodiments of the invention. As a beam pattern of collinear CARS the picture 701 is shown, whereas 702 shows the beam pattern of BoxCARS. The beam pattern of so called Folded BoxCARS is signed with 703 and 704 depicts the beam pattern of the so called USED BoxCARS. As the CARS signal increases quadratically with the beam interaction length (between pump and Stokes beam) it may be desirable to increase this interaction length.

To cut off any CARS signal from the incoming beam's overlap and from a first lens, the overlap length is delimited by a first glass filter 705. To prevent generation of CARS light in a second lens, the interaction length is stopped by a second glass filter 706. Depending on the desired spatial resolution and the 2-D separation of the beams at the receiver side a geometry 701 to 704 is chosen.

FIGS. 8 and 9 show a schematic diagram of the wave vectors of the CARS involved photons. Thereby 800 shows the case of collinear phase matching wherein the wave vector of pump photons 801, the wave vector of Stokes photons 802 and the wave vector of photons from the emitted CARS signal 803 are shown. The diagram of the involved wave vectors in BoxCARS phase matching is depicted in 900.

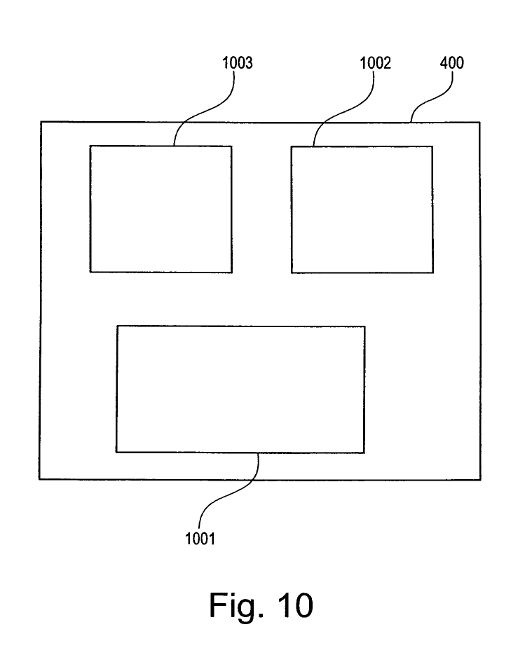

FIG. 10 depicts a sorting device according to a exemplary embodiment of the invention, wherein the devices comprises a first (1101), a second (1102) and a third subdevice (1103).

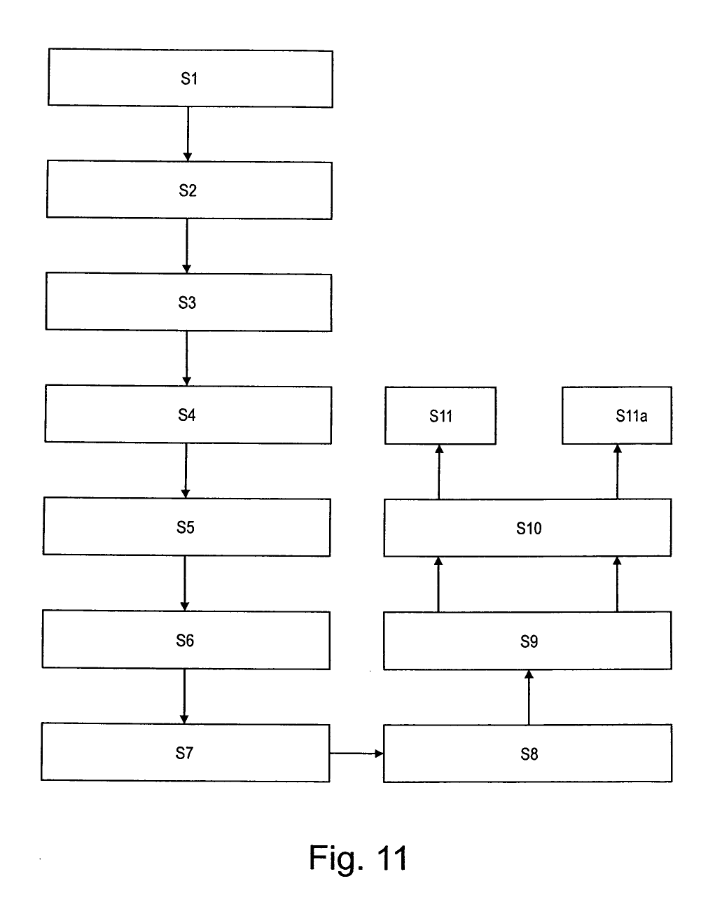

FIG. 11 schematically shows a flow diagram of a method according to an exemplary embodiment of the invention. Further steps S1 till S11 are shown.

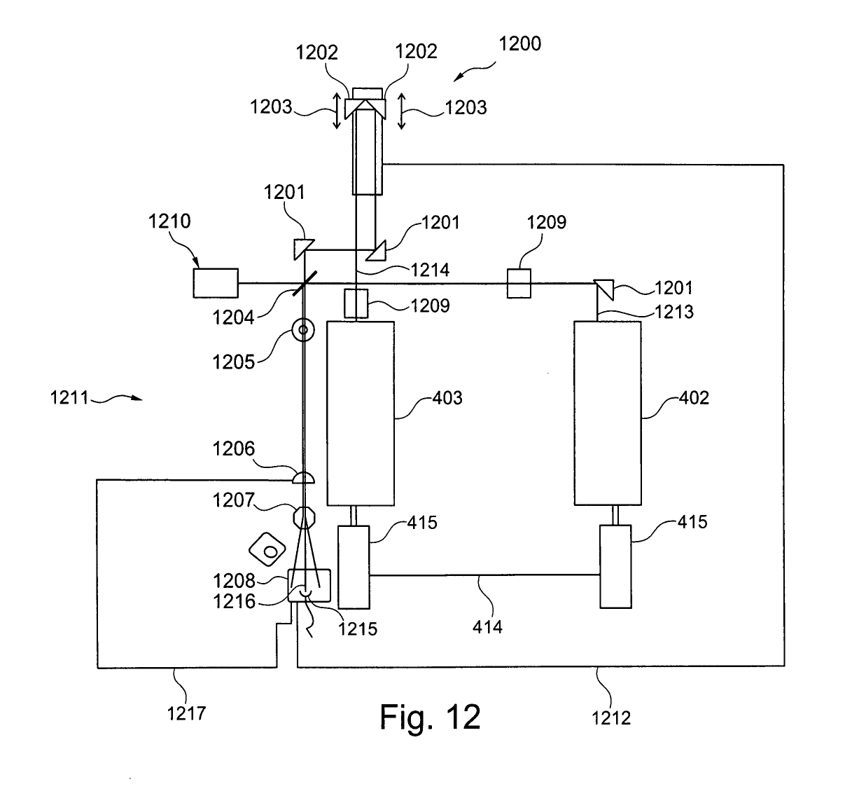

FIG. 12 shows a device 400 for sorting particles with a CARS set up and an integrated flow cytometer. It is shown that besides the two lasers 401 and 402 an optical delay line 1200 is applied. 1210 shows a subdevice with a flow cytometer and the sorting mechanism. Minors 1201 are used to guide the photons of the pump beam 1213 and the Stokes beam 1214 to a desired position. The delay line 1200 comprises mirrors 1201 and movable mirrors 1202 which can be positioned along the directions 1203 indicated by arrows. In other words the pump and Stokes photons can be matched by means of an appropriate adjustment of the delay line in such a way that they arrive at the same point of time at the same spatial coordinates, which coordinates define the predefined spot. This may be necessary to provide for the generation of a CARS process as described above. This is done in this exemplary embodiment of the invention by elongating or reducing the optical path length of the Stokes beam 1214. Nevertheless, this may also be applied to the pump beam 1213.

Furthermore the time of emission of firstly the photons of the first frequency and secondly the time of emission of the photons of the second frequency may be controlled and adapted in 400 in such a way, that both different types of photons arrive simultaneously at the desired and predefined spot. In other words the time delay is adapted to apply a zero time delay of the pump photons and the Stokes photons of the CARS generating device.

FIG. 12 further shows an additional optical arm 1211 starting at the beam splitter 1204. The optical arm comprises an iris 1205, a lens 1206 which focuses both beams onto a non linear crystal 1207, which may be formed e.g. out of BBO.

It is clearly shown that three beams are emitted by the non linear crystal, which beams have frequencies that have been doubled by the crystal. Firstly the frequency doubled pump beam and secondly a frequency doubled Stokes beam are emitted. Thirdly a beam is emitted, that results from the combination of the pump photons and the Stokes photons and which combination has also been frequency doubled by passing through the non linear crystal 1207. Each of the three different beams is detected independently by the mismatch detector 1208.

As the pump beam and the Stokes beam may be realized as pulsed photon packages the overlap of these packages is important. The better the time overlap and the spatial overlap of the pulsed photon packages is, the greater this detection signal of the combined and frequency doubled signal 1216 will be. In other words the better the matching is the brighter the signal 1216 will be. Therefore the measure of the signal 1216 detected by the detector 1215 is used to control the optical delay line 1200 by means of the feedback line 1212 from mismatch detector 1208 to the optical delay line. Additionally by connecting detector 1215 to e.g. an oscilloscope the quality of the matching may be visualized. As the pulses may range e.g. within the picosecond or femtosecond regime e.g. relatively fast diodes may applied. 1217 shows a feedback line from the mismatch detector to the focusing element being the lens 1206 to control the focusing parameters if desired.

FIG. 12 further shows optical isolators 1209 in front of the two lasers 402 and 403 in order to avoid a disadvantageous optical feedback. Back reflections from several parts are suppressed by the optical isolators that may be realized as optical diodes or e.g. Faraday isolators. Thus, erratic pulses are avoided. This increases the stability and accuracy of the measurements and sorting done with the device 400.

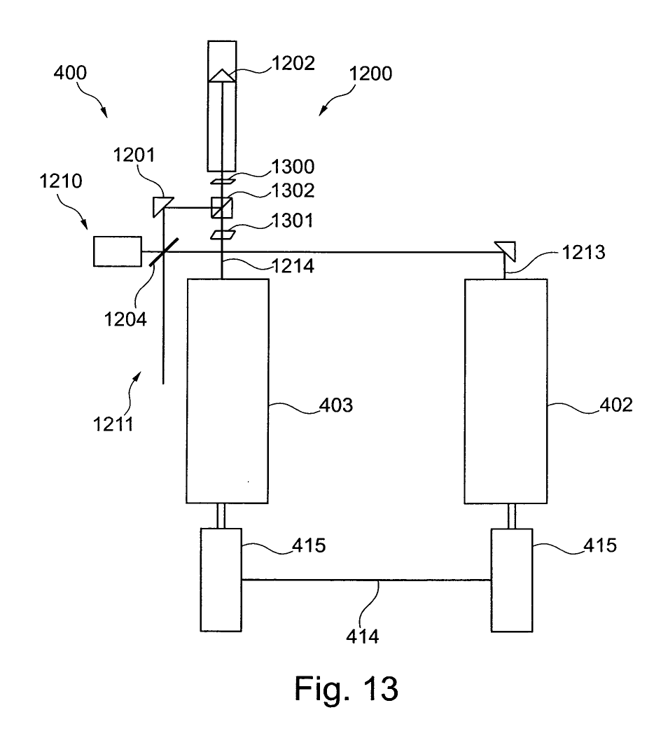

FIG. 13 shows a device 400 for sorting particles with a CARS set up and an integrated flow cytometer. It is shown that besides the two lasers 401 and 402 another exemplary embodiment of the optical delay line 1200 is applied. 1210 shows a subdevice with a flow cytometer and the sorting mechanism. The delay line consists of a mirror at 90° to the beam. The laser 403 is initially vertically polarized. The beam 1214 passes through a ½ wave plate 1301 rotating the polarization by 90°. The beam passes through a vertical polarizing beam splitter 1302 onto a ¼ wave plate 1300 where it is rotated by 45°. The beam hits the movable mirror 1202 perpendicular to the laser beam direction and is retro-reflected back though the ¼ wave plate rotating the laser beam's polarization by another 45° and thus making the polarization vertical again. The laser travels to the polarizing beam splitter 1302 and instead of passing through it is reflected. A 45° steering mirror reflects the laser onto a beam splitter 204. The light is passed onto the sorter and into an optical arm 1211 having a non linear crystal e.g. out of BBO (not shown here) to configure and control the matching of the pump photons and the Stokes photons.

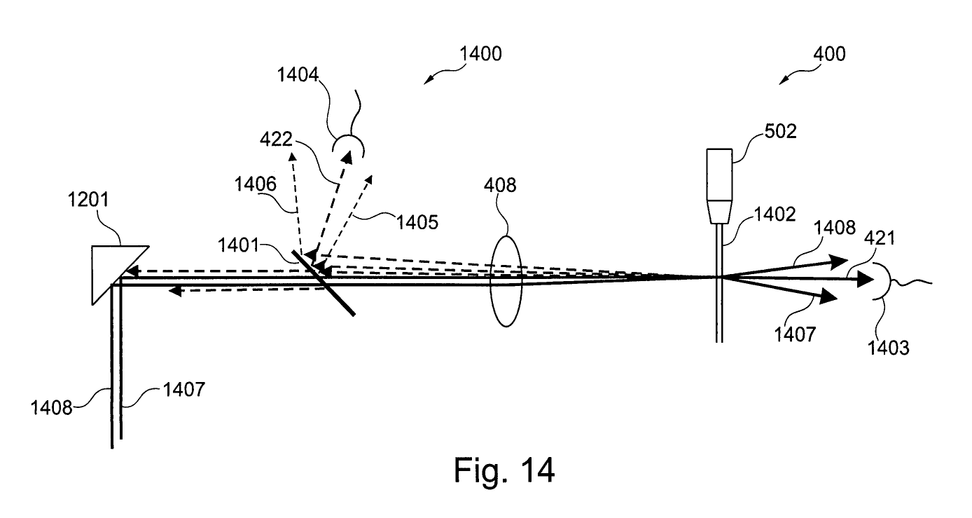

FIG. 14 shows a device 400 for sorting particles with an optical filter 1401 to isolate a backwards CARS signal 422 according to another exemplary embodiment of the present invention. The forward/incoming pump beam 1407 and the forward/incoming Stokes beam 1408 generate after being focused by the lens 408 the desired CARS signal in the particles. This detection setup 1400 for isolating the backwards CARS signal 422 shows the jet of particles within a cuvette 1402 that are to be sorted. The nozzle is shown with 502. 1403 shows a detector for forward CARS signal and 1404 shows a detector for backwards CARS signal. The back reflected pump beam 1405 and the back reflected Stokes beam 1406 are spatially separated from the signal 402 by reflection at the optical filter 1401. By means of using the backwards CARS signal additionally to the forward CARS signal 421 the whole measurement or detection may be increased in its sensitivity. Therefore the sorting may be more fast and/or more accurate when using both CARS signal. Thereby the two CARS signals are detected and measured independently.

It should be noted that in the context of the present invention the terms “beam” and “pulses” are used synonymously. In other words unless explicitly stated photon pulses as well as continuous wave regimes may both be applied and used in the context of the present invention.

In the claims, the word “comprising” does not exclude other elements or steps, and the indefinite article “a” or “an” does not exclude a plurality. Reference signs shall not limit the scope of this invention.

### LIST OF REFERENCE NUMERALS

100 energy scheme of the states of a particle
101 stokes shift
102 anti-Stokes shift
103 ground state of the particle
104 vibrational level
105 virtual state
106 electronic state
107 absorption of a photon/excitation of the particle
108 emission of a Stokes shifted photon
109 emission of an anti-Stokes shifted photon
200 diagram of modulated field due to combination of pump and Stokes beam
201 x axes in frequency (arbitrary units)
202 y axes in amplitude (arbitrary units)
203 carrier frequency of the modulated field
204 beat frequency of the modulated field
300 energy scheme of the states of a particle during CARS
301 excitation of a vibrational state 104 by equalizing the difference between the pump and Stokes frequency with the corresponding energy of the state 104
302 further excitation of the particle into a virtual state
303 stimulated emission of the anti-Stokes photon by another pump photon and therefore relaxation of the particle to the ground state
400 device for sorting particles with a CARS set up and an integrated flow cytometer
401 electronics
402 first laser
403 second laser
404 beam shaping components
405 dichroic mirror
406 dichroic mirror
407 beam stearing mirror
408 focusing lens
409 collecting lenses
410 mirrors for a forward or a backward CARS signal
411 detector for the forward and backward CARS signal
412 flow cytometer
413 particle jet after being analyzed with CARS
413a particle jet before being analyzed with CARS
414 communication lines for synchronizing detector and laser 1 and 2
415 oscillator for timing pulses and electronics
416 computing unit
417 computer readable medium
418 computer program element
419 synchronization device
420 focal point/area of interrogation or interaction of laser field with particles
421 forward CARS signal
422 backward CARS signal
423 sorting mechanism
424 first direction
425 second direction
426 first population of particles
427 second population of particles
500 lateral view of a cuvette of a flow cytometer
501 particle tube
502 nozzle body
503 laser interrogation area in a nozzle
504 jeweled nozzle
505 diameter of the particle tube
506 diameter of the nozzle body
507 plan view of a cuvette
600 lateral and plan view of a cuvette with a nozzle for a flow cytometer
601 laser interrogation area in a nozzle in lateral view
602 jeweled nozzle tip in plan view
603 plan view of laser interrogation area in a nozzle
604 plan view of jeweled nozzle tip
700 different beam patterns for phase matching
701 beam pattern of collinear CARS
702 beam pattern of BoxCARS
703 beam pattern of Folded BoxCARS
704 beam pattern of so called USED BoxCARS
705 first glass filter
706 second glass filter
800 diagram of wave vectors in collinear phase matching
801 wave vector of pump/probe photons
802 wave vector of Stokes photons
803 wave vector of photons from the CARS signal
900 diagram of wave vectors in BoxCARS phase matching
1001 first subdevice
1002 second subdevice
1003 third subdevice
1200 optical delay line
1201 mirror
1202 movable mirror
1203 directions of movement of movable mirror
1204 beam splitter
1205 iris
1206 lens focusing on non linear crystal
1207 non linear crystal
1208 mismatch detector
1209 optical isolator
1210 subdevice with flow cytometer and sorting mechanism
1211 optical arm with mismatch detector
1212 feedback line from mismatch detector to delay line
1213 pump beam
1214 Stokes beam
1215 detector for combined and frequency doubled signal
1216 combined and frequency doubled signal
1217 feedback line from the mismatch detector to the focusing element
1300 ¼ wave plate
1301 ½ wave plate
1302 polarizing beam splitter
1400 detection setup for isolating the backwards CARS signal
1401 optical filter
1402 jet of particles within a cuvette
1403 detector for forward CARS signal
1404 detector for backwards CARS signal
1405 back reflected pump beam
1406 back reflected Stokes beam
1407 forward/incoming pump beam
1408 forward/incoming Stokes beam
S1-S11 method steps

1. Method for sorting particles wherein the particles comprise at least one constituent, the method comprising:
providing the particles in a flow cytometry device;
detecting characteristics of the at least one constituent by coherent Anti-Stokes Raman spectroscopy; and
sorting the particles based on detection results.

2. The method according to claim 1,
wherein the particles are sperm;
wherein the sorting step comprises
sorting the sperm separately into X- and Y-chromosome-bearing populations.

3. The method according to claim 1, the method further comprising the following steps:
introducing the particles or a particle suspension to the centre of a flow of a sheath fluid, wherein to form a co-axial flow that is compartmentalised;
wherein the particles flow singly in a stream of the sheath fluid;
providing for a first coherent light source for emitting a first light beam comprising photons of a first frequency;
providing for a second coherent light source for emitting a second light beam comprising photons of a second frequency;
spatially overlapping the first and second light beams to generate a modulated light field at a focal point;
wherein the first and second photons are prepared in such a way, that their phases match at the focal point;
wherein the first and second frequencies are predefined in such a way, that a difference of the first and second frequency is equal to a vibrational eigenfrequency of the at least one constituent of the particle;
bringing the particles or the suspension of particles to an interaction with the modulated light field at the focal point;
stimulating an emission of a coherent blue shifted photon from the at least one constituent of a particle by the interaction with the modulated light field; and
using a signal of the blue shifted photon as detection result.

4. The method according to claim 3;
wherein the signal of the blue shifted photon is based on a DNA content of the particles.

5. The method according to claim 3;
wherein the difference of the first and second frequency is equal to a vibrational eigenfrequency of one of the elements out of the group consisting of a phosphate backbone of the DNA, a base adenine, a base thymine, a base guanine, a base cytosine and each other matter, that enables to differentiate between an X-sperm and an Y sperm.

6. The method according to claim 3;
further comprising the following step:
providing for a detector to detect the signal of the coherent Anti-Stokes Raman spectroscopy;
wherein the first and second light sources are pulsed lasers; and
wherein the detector is synchronized with laser pulses of the pulsed lasers.

7. The method according to claim 6;
wherein the detector is movable in order to detect a refractive signal from coherent Anti-Stokes Raman spectroscopy.

8. The method according to claim 3;
wherein the phase matching of the first and second photons is achieved by applying one of the techniques out of the group consisting of box car phase matching technique and trivial phase matching technique.

9. The method according to claim 1;
wherein the particles are irradiated with only two discrete frequencies of light during the coherent Anti-Stokes Raman spectroscopy.

10. Device for sorting particles, the particles having at least one constituent; the device comprising:
a first subdevice for flow cytometry purposes; and
a second subdevice for coherent Anti-Stokes Raman spectroscopy for detecting characteristics of the at least one constituent; and
a third subdevice for sorting the particles based on detection results.

11. The device according to claim 10, wherein the first subdevice comprises:
a particle entry section;
a sheath fluid entry section;
a flow chamber for introducing the particles to the centre of a flow of a sheath fluid; and
an exit section for the particles and the flow of the sheath fluid.

12. The device according to claim 10, wherein the second subdevice comprises:
a first coherent light source for emitting a first light beam comprising photons of a first frequency;
a second coherent light source for emitting a second light beam comprising photons of a second frequency;
at least one element for phase matching the photons of the first and second light source;
a first detector for detecting a coherent Anti-Stokes Raman signal; and
wherein the first and second frequencies are predefined in such a way, that a difference of the first and second frequency is equal to a vibrational eigenfrequency of the at least one constituent of the particle.

13. The device according to claim 10, the device further comprising:
a second detector for detecting a coherent Anti-Stokes Raman signal in a backward direction.

14. The device according to claim 10, further comprising:
an optical filter;
wherein the optical filter is adapted for separating a CARS signal in a backward direction from backwards reflected photons of a first frequency and from backwards reflected photons of a second frequency.

15. The device according to claim 10, the device further comprising:
an optical delay line;
wherein the optical delay line is adapted for matching photons of a first frequency with photons of a second frequency at a predefined spot.

16. The device according claim 15, the device further comprising:
an optical arm comprising a mismatch detector;
wherein the mismatch detector is adapted for measuring a mismatch between the photons of the first frequency and the photons of the second frequency.

17. The device according claim 16, the device further comprising:
a non linear crystal;
wherein the non linear crystal is adapted for converting the photons of the first frequency and the photons of the second frequency into one summed and converted photon.

18. The device according to claim 16,
wherein the device is adapted for controlling the mismatch between the photons of the first frequency and the photons of the second frequency based on a signal provided by the mismatch detector to the delay line.

19. The device according to claim 10, the device further comprising:
an analog digital converter (ADC) for converting the detection results;
a pulse laser's clock;
wherein the pulse laser's clock is used to coordinate the conversion in the ADC to synchronize a capture of a coherent Anti-Stokes Raman spectroscopy signal with excitation pulses of the coherent Anti-Stokes Raman spectroscopy.

20. The device according to claim 10, the device further comprising:
a nozzle;
wherein the nozzle is part of a cuvette;
wherein the first and the second subdevices are physically combined in such a way, that the interaction of the modulated light field and the particles happens within the nozzle.

21. Computer program element characterized by being adapted, when in use on a device for sorting particles, to cause the device for sorting particles to perform the steps of the method according to claim 1.
